(19) United States
(12) Patent Application Publication
(10) Pub. No.: US 2012/0010850 A1
(43) Pub. Date: Jan. 12, 2012

(54) MEASUREMENT APPARATUS AND METHOD

(75) Inventors: Akihiro NAKAUCHI, Utsunomiya-shi (JP); Ryuichi SATO, Sendai-shi (JP); Hideaki KITAMURA, Utsunomiya-shi (JP)

(73) Assignee: CANON KABUSHIKI KAISHA, Tokyo (JP)

(21) Appl. No.: 13/176,793

(22) Filed: Jul. 6, 2011

(30) Foreign Application Priority Data
Jul. 8, 2010 (JP) 2010-156186

(51) Int. Cl. G01B 11/24; G06F 15/00

(52) U.S. Cl. 702/167

(57) ABSTRACT

A measurement apparatus comprises a measurement head including a detector which detects an interference light between test light and reference light and a processing unit. The processing unit calculates an optical path length difference between the reference light and the test light from the detected interference light, calculates a test wavefront and a reference wavefront based on a nominal value of a shape of the surface to be measured and optical information of an optical component in the measurement head, calculates a wavefront difference, calculates a phase error, corrects the calculated optical path length difference based on the calculated phase error, calculates a distance between the reference point and the surface to be measured, and calculates the shape of the surface to be measured, based on the calculated distance between the reference point and the surface to be measured, and coordinates of the reference point.

### BACKGROUND OF THE INVENTION

1. Field of the Invention

The present invention relates to a measurement apparatus and method for measuring the shape of a surface to be measured.

2. Description of the Related Art

Conventionally, measurement apparatuses such as a Fizeau interferometer and Twyman-Green interferometer have been used to measure the surface shape of a spherical lens, aspherical lens, or the like. For example, Japanese Patent Laid-Open No. 2006-170777 discloses a surface shape measurement apparatus using a Fizeau interferometer.

### SUMMARY OF THE INVENTION

Surface shape measurement apparatuses require higher measurement accuracies. It is therefore an object of the present invention to provide a measurement apparatus capable of measuring the shape of a surface to be measured at high accuracy.

According to one aspect to the present invention, there is provided a measurement apparatus which measures a shape of a surface to be measured, comprising: a measurement head including a detector which detects an interference light between test light that passes through a reference point, is reflected by the surface to be measured, and returns to the reference point, and reference light; and a processing unit which calculates the shape of the surface to be measured, based on the interference light detected by the detector while scanning the measurement head along a scanning surface, wherein the processing unit calculates, from the interference light detected by the detector, an optical path length difference between the reference light and the test light, calculates a test wavefront of the test light and a reference wavefront of the reference light on the detector by optical calculation based on a nominal value of the shape of the surface to be measured and optical information of an optical component in the measurement head, calculates, from the calculated test wavefront and reference wavefront, a wavefront difference generated between the test light and the reference light, calculates, from the calculated wavefront difference, a phase error generated between the test light and the reference light owing to the wavefront difference, corrects the calculated optical path length difference based on the calculated phase error, calculates a distance between the reference point and the surface to be measured, based on the corrected optical path length difference, and calculates the shape of the surface to be measured, based on the calculated distance between the reference point and the surface to be measured, and coordinates of the reference point.

Further features of the present invention will become apparent from the following description of exemplary embodiments with reference to the attached drawings.

### BRIEF DESCRIPTION OF THE DRAWINGS

FIG. 1 is a flowchart showing a measurement sequence according to the first embodiment;

FIG. 2 is a view for explaining the measurement head of a measurement apparatus;

FIG. 3 is a view for explaining a measurement apparatus according to the first embodiment;

FIG. 4 is a flowchart showing a measurement sequence according to the second embodiment;

FIG. 5 is a flowchart showing a measurement sequence according to the fourth embodiment; and

FIG. 6 is a view for explaining a measurement apparatus according to the fifth embodiment.

### DESCRIPTION OF THE EMBODIMENTS

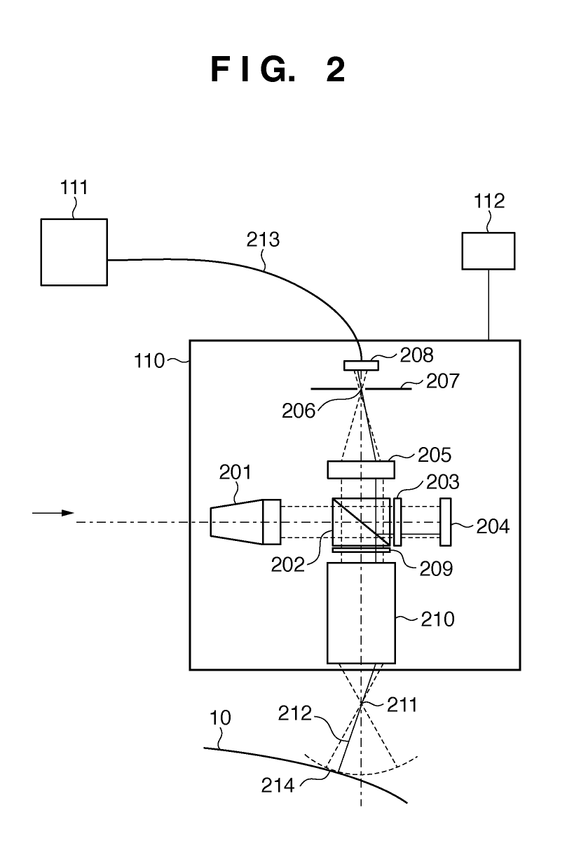

A measurement apparatus which measures the shape of a surface to be measured will be described with reference to FIG. 2. The measurement apparatus includes a measurement head 110, a scanning mechanism 112 which scans the measurement head 110 along the scanning surface, and a processing unit 111. FIG. 2 shows a case in which the measurement head 110 emits a spherical wave and the center of the spherical wave is defined as a reference point. Referring to FIG. 2, a reference point (s, t, u) denoted by reference numeral 211 is the center of a spherical wave emitted by the measurement head 110. A point (x, y, z) denoted by reference numeral 214 is a point where reflected light returns to the reference point again when a spherical wave having the reference point 211 as the center is reflected by a surface 10 to be measured. That is, light traveling from the reference point strikes the point 214 perpendicularly and is reflected perpendicularly. This light will be called vertical incident light. A distance q denoted by reference numeral 212 is a vertical distance between the point 214 and the reference point 211. The measurement apparatus measures the coordinates of the reference point 211 and the distance q while scanning the measurement head 110, and determines the coordinate group of the point 214 on the surface 10 to be measured, that is, the surface shape based on the measurement result. Details of this processing are described in an application (Japanese Patent Application No. 2010-083399) by the present applicant.

Since the point 214 (x, y, z) is located on a spherical surface having the reference point 211 (s, t, u) as the center and a radius q, equation (1) is established:

(x−s)²+(y−t)²+(z−u)²=q² (1)

Partially differentiating the two sides of equation (1) by s, t, and u yields equation (2):

(x, y, z)=(s, t, u)−q·(∂q/∂s, ∂q/∂t, ∂q/∂u) (2)

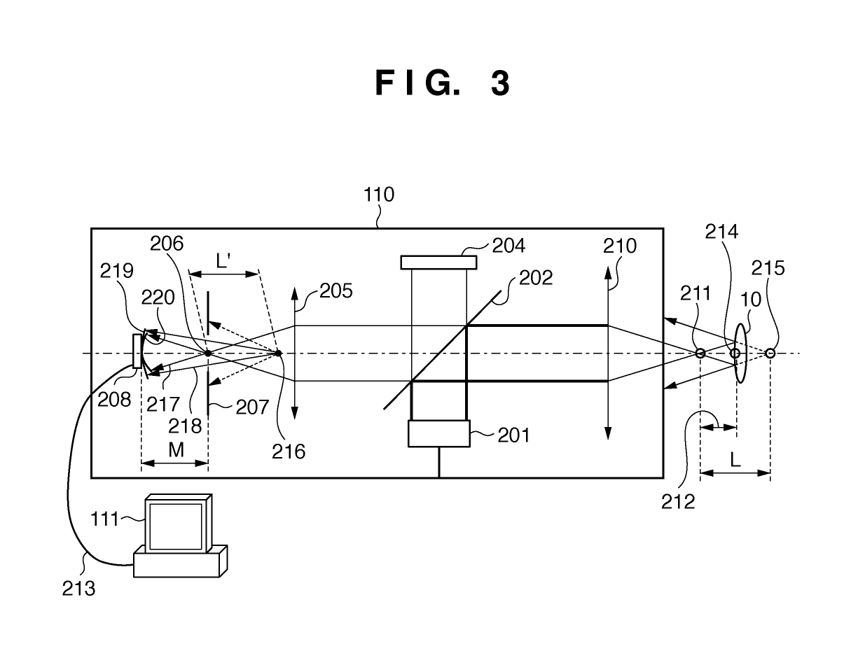

The action of the measurement head 110 will be explained optically. FIG. 3 shows the power position of the measurement head 110 shown in FIG. 2. The illumination optical system includes a beam expander 201, beam splitter 202, and objective lens 210. The light receiving optical system includes the objective lens 210, the beam splitter 202, an imaging lens 205, and an aperture 207. The beam splitter 202 splits a beam emitted by the beam expander 201 into transmission light and reflected light. The transmission light propagates toward a reference surface 204, whereas the reflected light propagates toward the surface 10 to be measured. The transmission light which has reached the reference surface 204 is reflected by the reference surface 204, serves as reference light, is reflected by the beam splitter 202, and then propagates toward the imaging lens 205.

To the contrary, the reflected light propagating toward the surface 10 to be measured enters the objective lens 210. The reflected light is converted into a spherical wave having the focal point 211 of the objective lens 210 as the center of curvature, and then reflected by the surface 10 to be measured. The light reflected by the surface 10 to be measured returns as test light to the objective lens 210, passes through the beam splitter 202, and propagates toward the imaging lens 205. The reference light and test light act as an interference wave (light), and the interference wave reaches, through the imaging lens 205, a detector 208 which detects the interference wave. The detector 208 photoelectrically converts the interference signal, detecting a measurement signal. As the detector 208, a photodiode such as an avalanche photodiode or pin photodiode is used.

By the action of the opening of the aperture 207 arranged at a position conjugate to the focal point 211 of the objective lens 210, only an almost vertically incident component of the test light reflected by the surface 10 to be measured is selected and enters the detector 208. The remaining components are cut off outside the opening of the aperture 207. The diameter of the opening of the aperture 207 is determined by the lateral resolution in measurement of the surface 10 to be measured and the light quantity necessary for the detector 208. The diameter of the aperture 207 can be set small in terms of the lateral resolution or large in terms of ensuring the necessary light quantity. The aperture diameter is optimized in a tradeoff between them. The measurement signal by the detector 208 is provided to the processing unit 111 via a cable 213. The processing unit 111 analyzes the measurement signal, detecting the optical path length difference between the reference light and the test light and measuring the distance q.

Light reflected by the surface 10 to be measured receives the action of power based on the radius R of curvature of the surface 10 to be measured, and thus is not condensed at the focal point 211 of the objective lens 210. Even an image on the side of the detector 208 by the objective lens 210 and imaging lens 205 is not condensed at a point 206 serving as the center of the opening of the aperture 207. In contrast, reference light is always condensed at the center 206 of the opening of the aperture 207. Depending on a distance L′ between the focal positions of the reference light and test light on the side of the detector 208, interference fringes having a power difference enter the detector 208. For example, when the surface 10 to be measured is flat, an image corresponding to the surface 10 to be measured at the focal point 211 is formed at a point 215 spaced apart from the focal point 211 by L=2q in accordance with paraxial calculation. The image at the point 215 through the objective lens 210 and imaging lens 205 is formed at a position 216 spaced apart from the point 206 by L′. L′ is the distance determined by the power layout of the objective lens 210 and imaging lens 205.

When an interference wave generated by two spherical waves of test light and reference light whose center positions are spaced apart by L′ has a power difference ΔP, a phase error Δφ is generated by (ΔP/2) as a phase which is detected by the detector 208 and calculated by the processing unit 111. As an example of calculating a phase error amount, assume that the surface 10 to be measured is flat, the diameter of the aperture 207 is 1 [nm], the distance q is 5 [nm], and the imaging magnification β by the objective lens 210 and imaging lens 205 is 10. Then, the power difference ΔP based on paraxial calculation is a PV (Peak to Valley) value of about 125 nm, and the phase error Δφ is about 60 [nm]. The numerical value of the power difference ΔP is given by a PV value. Details of the calculation will be described in embodiments.

The aspherical lens employed in the above-described optical system requires a measurement accuracy of about 10 nm, but the presence of the above-mentioned phase error Δφ based on the power difference is problematic. To reduce the phase error Δφ, the diameter of the opening of the aperture 207 needs to be set small. However, this leads to shortage of the quantity of interference light entering the detector 208, as described above. Embodiments for reducing a measurement error arising from the phase error of the measurement apparatus will be explained below.

### First Embodiment

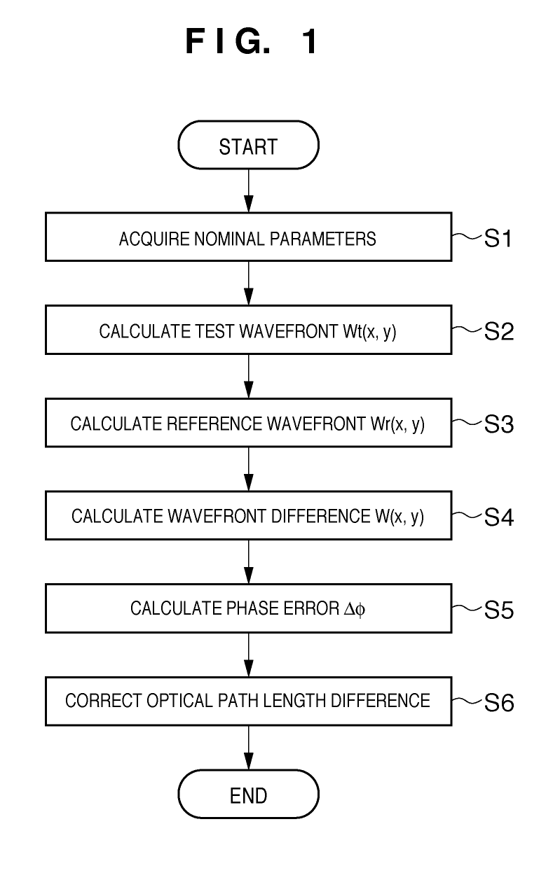

The first embodiment will be described with reference to FIGS. 1 and 3. FIG. 1 shows a calculation sequence, and FIG. 3 is a view for explaining a measurement head 110. A wavefront difference W is generated between reference light and test light because, for example, test light which comes from the reference point 211 and perpendicularly strikes the surface 10 to be measured is not condensed at the reference point 211, as described above. The wavefront difference W generates the phase error Δφ, and thus the optical path length error. To solve this, the first embodiment uses a processing unit 111 to perform correction calculation for the optical path length difference. FIG. 1 shows the sequence of optical path length difference correction calculation performed by the processing unit 111. In step S1, the processing unit 111 acquires the nominal parameters of the surface 10 to be measured. The nominal parameters are the nominal value Zc(x, y) of the shape of the surface 10 to be measured, optical information of optical components in the measurement head, the distance qc between the points 211 and 214 serving as a measurement condition, and the nominal values of measurement coordinates (xc, yc, zc) on the surface 10 to be measured. Each information item is saved in the storage unit of the processing unit 111, or input by the user and if necessary, calculated and derived. Of these nominal parameters, the nominal value Zc(x, y) of the shape of the surface 10 to be measured can be the paraxial radius of curvature, effective diameter, conic constant, high-order aspherical coefficient, or the like. These values may be design values, or approximate values measured at lower accuracy. Also, the nominal value Zc(x, y) of the shape of the surface to be measured may be given by a point group (xi, yi, zi).

Optical information of optical components in the measurement head can include the radius of curvature of an optical component which builds the measurement head 110, interval, refractive index, opening diameter information, aspherical coefficient information, and the radius h of the opening of the aperture 207. Also, manufacturing error information measured in the manufacture of each optical component can be given to perform higher-accuracy optical calculation. For simplicity of calculation, optical information of optical components in the measurement head may be the focal length or interval information of an optical component based on the power layout of the optical system in the measurement head 110. Further, the optical information may include the optical magnification β and the aperture radius h of the aperture 207. The distance qc between the points 211 and 214 serving as a measurement condition, and the measurement coordinates (xc, yc, zc) on the surface 10 to be measured are calculated by the processing unit 111 based on shape information Zc(x, y) of the surface 10 to be measured. The distance qc is determined based on the condition of collision between the measurement head 110 and the surface 10 to be measured, the light quantity condition along with a change of the distance qc, and the like. The user may set the distance qc.

In step S2, the processing unit 111 calculates a test wavefront Wt(x, y) from the surface 10 to be measured on a detector 208, based on the nominal value Zc(x, y) of the shape of the surface 10 to be measured, and optical information of optical components in the measurement head. First, the processing unit 111 calculates a test wavefront Wt′(x, y) serving as a wavefront immediately after reflection on the surface 10 to be measured. Then, the processing unit 111 calculates a local shape Mt(x, y) of the surface to be measured in a region D having, as the center, the coordinates (xc, yc, zc) of a measurement point 214 on the surface 10 to be measured. The processing unit 111 performs optical calculation of a reflected wavefront Wt′(x, y) when a spherical wave enters the local shape Mt(x, y) of the surface to be measured. The region D corresponds to a region extracted on the surface 10 to be measured in correspondence with the opening of the aperture 207.

The reflected wavefront Wt′(x, y) undergoes wavefront propagation calculation up to the detector 208 based on optical information of optical components in the measurement head serving as a nominal parameter, calculating the test wavefront Wt(x, y) on the first detector 208. The optical information of optical components in the measurement head can include the focal length or interval between an objective lens 210 and an imaging lens 205, and position information of the aperture 207 and detector 208. If high-accuracy calculation is necessary, manufacturing error information of optical components may be used as the optical information of optical components in the measurement head to execute wavefront propagation calculation. The manufacturing error information is, for example, the surface shape processing error of an optical component, the refractive index error of the glass material, or ununiformity error.

In step S3, the processing unit 111 calculates a reference wavefront Wr(x, y), on the detector 208, of reference light reflected by a reference surface 204. The calculation is based on optical information of optical components in the measurement head which is one of the nominal parameters. In step S4, the processing unit 111 calculates the wavefront difference W(x, y) between the reference light and the test light on the detector 208 using equation (3):

W(x, y)=Wt(x, y)−Wr(x, y) (3)

In step S5, the processing unit 111 calculates the phase error Δφ using equation (4) based on the wavefront difference W(x, y):

Δφ=Wm−W0 (4)

where Wo is the phase at the center position of the wavefront difference W(x, y), in which the center position corresponds to a position where vertically incident light reaches, and Wm is the average phase given by equation (5):

A·cos(Wm)=ƒ cos(W)x, y))·d×dy (5)

The integration region on the right-hand side of equation (5) is the same range as a range where the detector 208 detects an interference fringe. On the left-hand side, A is an amount corresponding to the modulation of the detection signal. The integration in equation (5) is expressed and used in the form of sum in numerical calculation.

In step S6, the processing unit 111 performs correction calculation by the phase error for the optical path length difference φ between the reference light and the test light that is measured using equation (6):

φ′=φ−Δφ (6)

Based on the corrected optical path length difference φ′, the processing unit 111 calculates the measurement value of the distance q. Further, the processing unit 111 calculates the shape of the surface 10 to be measured according to equation (2), measuring the shape of the surface 10 to be measured at high accuracy.

### Second Embodiment

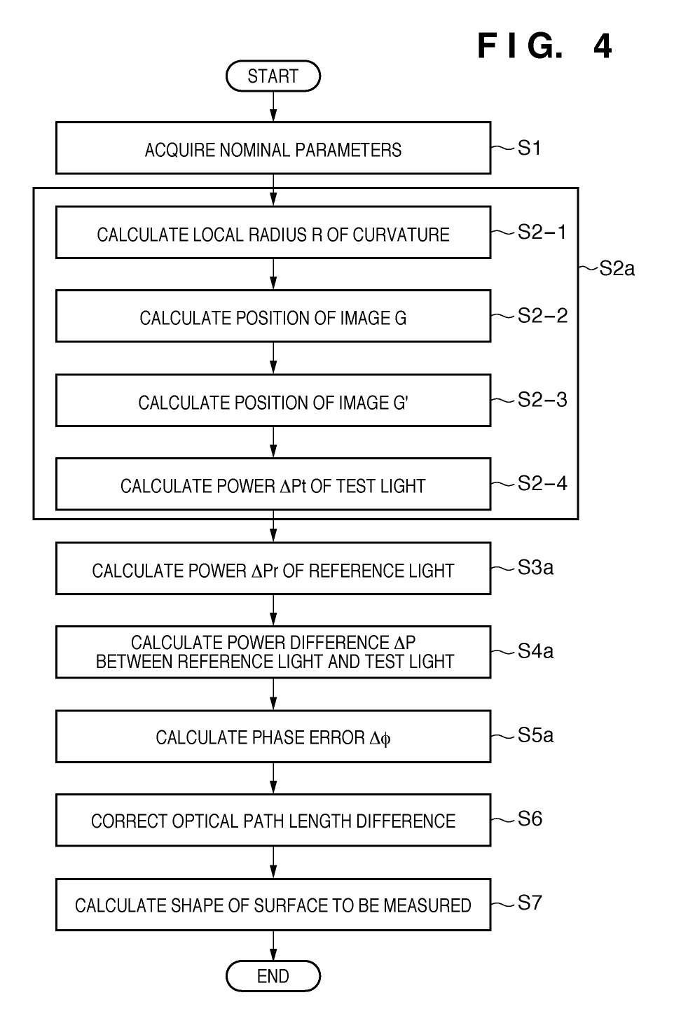

Another embodiment pertaining to calculation of the wavefront difference W(x, y), which corresponds to steps S2 to S5 in the first embodiment, will be explained. In general, light reflected by an aspherical lens or toric lens contains wavefront components different in power between the meridional direction and the sagittal direction, and wavefront components having a spherical aberration component, astigmatism component, and coma component, in addition to a power component serving as a main component. However, when the components other than the power component are negligibly small, the test wavefront Wt(x, y) can be approximated by only the power component ΔP. The second embodiment in which the power difference ΔP is obtained by a geometrical method (geometrical optical calculation) based on only the properties of the destination of traveling light while ignoring the wave motion and quantum of light will be explained with reference to FIG. 4.

Step S1 is the same as that in the first embodiment. A sequence in the second embodiment that corresponds to step S2 is given by step S2a. Step S2a includes four steps S2-1 to S2-4. In step S2-1, a processing unit 111 calculates the local radius R of curvature at the coordinates (xc, yc, zc) of a measurement point 214 on a surface 10 to be measured, based on shape information Zc(x, y) of the surface 10 to be measured. When the surface 10 to be measured is a spherical surface, the local radius R of curvature is the radius of curvature itself. When the surface 10 to be measured is a rotational symmetrical aspheric surface or toric surface, the local radius of curvature changes depending on the direction. Thus, local radii of curvature in two orthogonal directions are calculated in accordance with equations (7), using the average value of them:

### R=(Rx+Ry)/2

Rx=(1+Zc′(x)̂2)̂(3/2)/Zc″(x)

Ry=(1+Zc′(y)̂2)̂(3/2)/Zc″(y) (7)

where Zc′(x) is the first-order differential of Zc(x, y) by x, and Zc″(x) is the second-order differential. As for local radii of curvature in two orthogonal directions, the meridional and sagittal directions may be employed, or two, lengthwise and widthwise directions may be adopted for a toric surface.

In calculation of the local radius R of curvature, the region D on the surface 10 to be measured is fitted spherically, and the radius of curvature of this spherical surface is defined as the local radius R of curvature. The region D corresponds to a region extracted on the surface 10 to be measured in correspondence with the opening of an aperture 207. The region D is effective when the surface 10 to be measured is a free-form surface. Even when the shape information Zc(x, y) is given by the point group (xi, yi, zi), a spherical component in the region D is fitted and calculated using the point group, and the radius of curvature of the calculated spherical component is used as the local radius R of curvature.

In step S2-2, the processing unit 111 calculates a distance L between an image 215 of a focal point 211 of an objective lens 210 by the surface 10 to be measured and the focal point 211 using equation (8) based on the distance qc serving as a nominal parameter measurement condition and the local radius R of curvature calculated in step S1:

L=qc·(1+1/(1+2(qc/R))) (8)

In step S2-3, the processing unit 111 calculates a distance L′ between an image 216 of the point 215 on the side of a detector 208 and a point 206 serving as the image of the focal point 211 of the objective lens using equation (9) based on optical information in a measurement head 110 serving as a nominal parameter:

L′=L/β̂2 (9)

where β is the optical magnification which is optical information serving as a nominal parameter of the measurement head 110.

In step S2-4, the processing unit 111 calculates the power component ΔPt of test light, which corresponds to the test wavefront Wt(x, y) in the first embodiment. Since the test light has become a spherical wave having the point 216 as the center on the detector 208, equation (10) is established:

ΔPt=hd̂2/2/(L′+M) (10)

where hd is the radius of an interference wave detected by the detector 208, and M is the distance between the aperture 207 and the detector 208.

The radius of the interference wave on the detector 208 is calculated in accordance with equation (11) based on the radius h of the opening of the aperture 207:

hd=h·(L′+M)/L′ (11)

In step S3a, similar to the test light, the processing unit 111 calculates even the power component ΔPr of reference light on the detector 208 using equation (12):

ΔPr=hd̂2/2/M (12)

The reference light is condensed at the opening of the aperture 207, and thus can be expressed as a spherical wave using the point 206 as the center on the detector 208.

In step S4a, the processing unit 111 calculates the power difference ΔP between the test light and the reference light using equation (13):

ΔP=ΔPt−ΔPr (13)

In step S5a, the processing unit 111 calculates the phase error Δφ between the test light and the reference light using equation (14) based on the power difference ΔP:

Δφ=ΔP/2 (14)

Finally, in step S6, similar to the first embodiment, the processing unit 111 performs correction calculation for the optical path length difference between the test light and the reference light.

### Third Embodiment

The accuracy can be improved by taking account of the influence of diffraction in calculation of the power component of a reflected wavefront from a surface 10 to be measured. When the amplitude of a beam has a Gaussian distribution, letting w0 be the beam waist diameter of the beam, the radius Rw of curvature of a wavefront at a distance z from the beam waist can be given by equation (15):

Rw=z·(1+(a/z)̂2)

for a=π·w0̂2/λ (15)

where λ is the wavelength of the light source.

The relation between a distance z0′ and radius w0′ of the beam waist after an optical member propagates a beam waist with the radius w0 to a position corresponding to the distance z0 from the principal plane of an optical member having the focal length f can be given by equations (16):

w0′=w0·f/sqrt((f−z0)̂2+â2)

z0′=f−(f+z0)·(w0′/w0)̂2 (16)

Diffraction equations (14) and (15) can be used to calculate a power component ΔPt equivalent to a power component calculated in step S2a of the second embodiment. The power component ΔPt is calculated as follows. A processing unit 111 defines a focal point 211 of an objective lens 210 as the first beam waist, and uses the focal length f based on the local radius R of curvature at a measurement point 214 to calculate the second beam waist position and beam radius after reflection on a surface to be measured in accordance with equations (16). In this case, the focal length f is 1/R.

Based on the position and radius of the second beam waist and optical information in a measurement head 110 serving as a nominal parameter, the processing unit 111 calculates the position and radius of the third beam waist on the side of a detector 208 through the objective lens 210 and an imaging lens 205 in the measurement head 110. From the distance between the third beam waist position and the detector 208, and the beam waist radius at the position of the third beam waist, the processing unit 111 calculates the radius Rw of curvature of the wavefront of test light on the detector 208 in accordance with equation (15). Similarly, even for reference light, the processing unit 111 calculates the radius Rwr of curvature of the wavefront on the detector 208 using equations (15) and (16).

The processing unit 111 calculates the power difference ΔP between the test light and the reference light on the detector 208 using equation (17) based on the radius Rw of curvature of the wavefront of the test light and the radius Rwr of curvature of the wavefront of the reference light:

ΔP=ΔPt=hd̂2/2×(1/Rw−1/Rwr) (17)

where hd is the radius of interference light detected by the detector 208, as described above.

The processing unit 111 calculates the calculation error Δφ using equation (14) based on the power difference ΔP, similar to step S5 of the second embodiment.

In the above description, the amplitude has a Gaussian distribution, but a propagation equation for the beam waist of a so-called truncated beam in consideration of the influence of the opening of the optical system of the measurement head is also available. The wavefront difference W or power difference ΔP can also be calculated by calculating the wavefronts of test light and reference light on the detector 208 using a Fraunhofer diffraction or Fresnel diffraction equation. In the third embodiment, the focal point 211 of the objective lens 210 is used as the first beam waist. However, the beam waist position of a beam before entering a beam expander 201 may be propagated through the beam expander 201 and objective lens 210 and defined as the first beam waist position.

### Fourth Embodiment

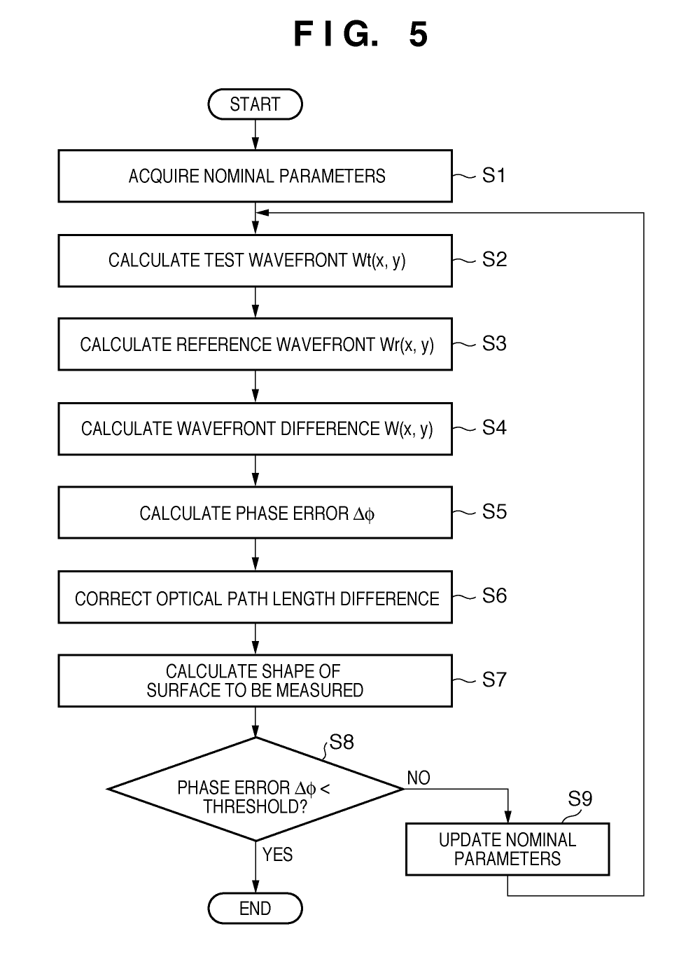

The fourth embodiment will be described with reference to the flowchart of FIG. 5. The method of the fifth embodiment enables more accurate measurement than in the first or second embodiment. The process up to step S6 is the same. In step S7, a processing unit 111 calculates the shape of a surface to be measured. In step S8, the processing unit 111 determines the magnitude of a phase error Δφ. If the phase error Δφ is equal to or larger than a threshold, the process advances to step S9. In step S9, the processing unit 111 updates the nominal value Zc(x, y) of the shape of a surface 10 to be measured to the shape of the surface to be measured that has been calculated in step S7. This update makes the nominal value Zc(x, y) closer to the measured shape of the surface. More specifically, the initial nominal value Zc(x, y) is a design value, or an approximate shape measured by a lower-accuracy measurement device is input. Since a shape of the surface 10 to be measured that is closer to an actual shape has been calculated in calculation of steps S1 to S7, the nominal value Zc(x, y) is updated to the calculated shape. The process returns to step S2, and the processing unit 111 calculates the shape of the surface to be measured again using the updated nominal value. If the phase error Δφ is equal to or larger than the threshold in step S8, the process advances to step S9 again. If the phase error Δφ becomes smaller than the threshold, the calculation ends.

In calculation of the shape of the surface to be measured in step S7, even the installation error of the surface 10 to be measured with respect to the measurement apparatus and information of the distance qc can be calculated. These pieces of information can also be updated as nominal parameters in step S9. The threshold of the phase error Δφ in step S8 can be set to a value at which the difference between the current phase error Δφ and an immediately preceding phase error Δφ in the repetitive process becomes equal to or smaller than a measurement accuracy required. Alternatively, the user can separately designate a value.

### Fifth Embodiment

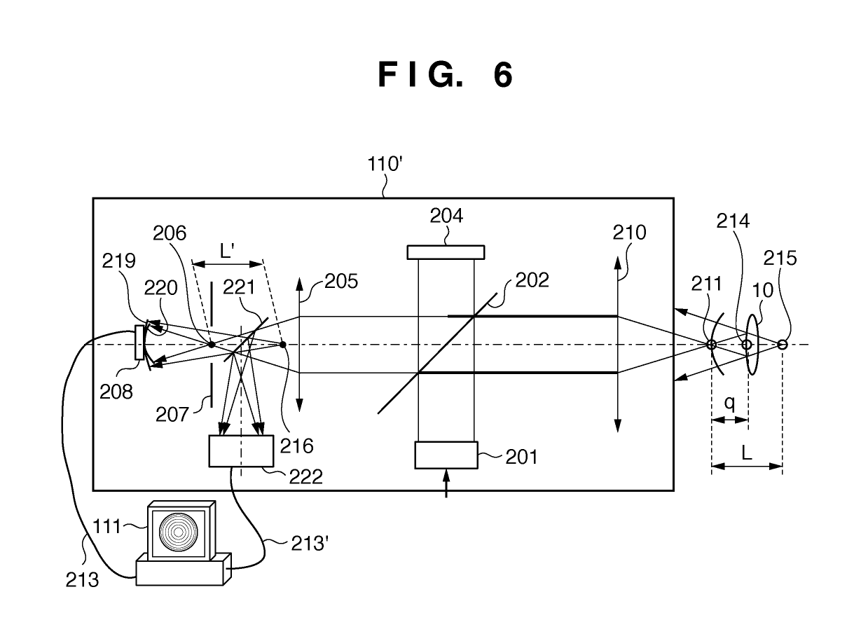

The fifth embodiment will be described with reference to FIG. 6. FIG. 6 is a view for explaining a measurement head 110′ pertaining to point scanning surface shape measurement according to the fifth embodiment. The measurement head 110′ is different from the measurement head in each of the first to fourth embodiments shown in FIG. 3 in that the measurement head 110′ in the fifth embodiment includes two detectors for detecting an interference wave between test light and reference light. A first detector 208 photoelectrically converts the interference wave having passed through an aperture 207 after an imaging lens 205, detecting a measurement signal. As the first detector 208, a photodiode such as an avalanche photodiode or pin photodiode is used. The measurement signal by the first detector 208 is provided to a processing unit 111 via a cable 213. The processing unit 111 analyzes the measurement signal, detecting the power difference φ between the reference light and the test light and measuring the distance q.

A second beam splitter 221 is interposed between the imaging lens 205 and the aperture 207, and reflects part of the interference wave. The reflected interference wave enters a second detector 222, and is photoelectrically converted, sending an electrical signal to the processing unit 111 via a cable 213′. The processing unit 111 calculates the wavefront difference W(x, y) between the test light and the reference light. The second detector 222 is arranged at a position optically conjugate to the first detector 208, and can detect the same interference fringe as that when the first detector 208 detects a phase. As the second detector 222, a two-dimensional array sensor such as a CCD sensor or CMOS sensor is used. When detecting only a power component, a one-dimensional array sensor suffices. Alternatively, a Shack-Hartmann sensor can be employed.

Since the first detector 208 for detecting the phase φ of an interference wave requires high data output rate, a photodiode having high response frequency is desirably used. In contrast, the second detector 222 requires an array sensor for wavefront detection and has low data output rate. It is therefore difficult to correct an error caused by the wavefront difference W at the same rate as the data output rate of the phase φ by the first detector 208. However, the local radius R of curvature of the surface to be measured and the distance q change more gradually than the output rate of the phase φ, and the wavefront difference W also changes gradually. Thus, satisfactory calculation correction can be achieved using even a low-frequency array sensor.

A method of calculating the phase error Δφ between test light and reference light by the processing unit 111 will be explained. The processing unit 111 performs the following three steps, S1 to S3. In step S1, the processing unit 111 calculates the center phase Wo of a wavefront difference W(x, y) from the detection result of the second detector 222. In step S2, the processing unit 111 calculates an average phase Wm obtained by equation (18):

A·cos(Wm)=ƒ cos(W(x, y))·d×dy (18)

The integration region on the right-hand side of equation (18) is the same range as a range where the first detector 208 detects an interference fringe. On the left-hand side, A is an amount corresponding to the modulation of the detection signal.

In step S3, the processing unit 111 calculates the phase error Δφ based on equation (19):

Δφ=Wm−W0 (19)

By using the phase error Δφ, the processing unit 111 corrects the optical path length difference between the reference light and the test light that has been calculated based on the measurement signal obtained by the first detector 208. In calculation of the center phase Wo, the influence of noise can be reduced by calculating the phase Wo at the center coordinates after low-pass-filtering the wavefront difference W(x, y) or performing Zernike function fitting or power series fitting. The arrangement of the second detector 222 is arbitrary as long as it is a position conjugate to the first detector 208. For example, the second beam splitter may be interposed between the aperture 207 and the first detector 208 to deflect a beam. It is also possible that the first detector 208 is formed from an array sensor and has a function of detecting both the wavefront difference W and phase φ. In this case, the use of the array sensor decreases the sampling frequency of phase φ detection. However, if high-speed measurement is unnecessary, the second beam splitter 221 and second detector 222 can be omitted, decreasing the size and weight of the measurement head 110′.

### Sixth Embodiment

In general, light reflected by an aspherical lens or toric lens contains wavefront components different in power between the meridional direction and the sagittal direction, and wavefront components having a spherical aberration component, astigmatism component, and coma component, in addition to a power component serving as a main component. However, for a surface to be measured on which the components other than the power component are negligibly small, the power difference ΔP can be measured instead of the wavefront difference W to calculate and correct the phase error Δφ. This can simplify a second detector 222 and decrease the calculation burden on a processing unit 111.

The calculation sequence includes the following two steps. In step S1, the processing unit 111 calculates the power component PWR(x, y) of the wavefront difference W(x, y) from the detection result of the second detector 222. The PV value of the power component serves as the power difference ΔP between test light and reference light. In step S2, the processing unit 111 calculates the phase error Δφ using equation (20):

Δφ=ΔP/2 (20)

In calculation of the power difference ΔP in step S1, the power difference can be calculated by extracting a spherical component from the wavefront difference W(x, y), or by performing fitting calculation based on a quadratic containing a constant term b, like equation (21):

PWR(x, y)=ΔP·(x̂2+ŷ2)+b (21)

A region where PWR(x, y) is calculated from the wavefront difference W(x, y) is the same range as a range where a first detector 208 detects an interference fringe. The second detector 222 may take an arrangement using an array sensor or Shack-Hartmann sensor, similar to the fourth embodiment. Also, the second detector 222 can be a detector using a principle of arranging the second aperture at a position conjugate to an aperture 207, detecting the quantities of test light and reference light having passed through the second aperture, and reading a change of the focus from changes of the detected light quantities. In this case, the power difference ΔP is calculated from a change of the focus. In addition, the second detector 222 can adopt a method of reading a shift in a direction perpendicular to the optical axis of test light at the focal position upon a change of the focus by an array sensor or four-segment sensor arranged at a position conjugate to the aperture 207. In the above embodiments, the shape of a surface to be measured is calculated by measuring only the distance using the measurement head. However, the present invention is not limited to this, and both the distance and direction may be measured as described in Japanese Patent Laid-Open No. 2002-116010.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-156186, filed Jul. 8, 2010, which is hereby incorporated by reference herein in its entirety.

What is claimed is:

1. A measurement apparatus which measures a shape of a surface to be measured, comprising:
a measurement head including a detector which detects an interference light between test light that passes through a reference point, is reflected by the surface to be measured, and returns to the reference point, and reference light; and
a processing unit which calculates the shape of the surface to be measured, based on the interference light detected by the detector while scanning said measurement head along a scanning surface,
wherein said processing unit calculates, from the interference light detected by the detector, an optical path length difference between the reference light and the test light,
calculates a test wavefront of the test light and a reference wavefront of the reference light on the detector by optical calculation based on a nominal value of the shape of the surface to be measured and optical information of an optical component in the measurement head,
calculates, from the calculated test wavefront and reference wavefront, a wavefront difference generated between the test light and the reference light,
calculates, from the calculated wavefront difference, a phase error generated between the test light and the reference light owing to the wavefront difference,
corrects the calculated optical path length difference based on the calculated phase error,
calculates a distance between the reference point and the surface to be measured, based on the corrected optical path length difference, and
calculates the shape of the surface to be measured, based on the calculated distance between the reference point and the surface to be measured, and coordinates of the reference point.

2. The apparatus according to claim 1, wherein said processing unit calculates the test wavefront and the reference wavefront as a power component of the test light and a power component of the reference light, respectively.

3. The apparatus according to claim 2, wherein said processing unit calculates the power component of the test light and the power component of the reference light by one of geometrical optical calculation and optical calculation considering diffraction.

4. The apparatus according to claim 1, wherein said processing unit repetitively updates the nominal value of the shape of the surface to be measured to the calculated shape of the surface to be measured and calculates again the shape of the surface to be measured using the updated nominal value until the phase error becomes smaller than a threshold.

5. A measurement apparatus which measures a shape of a surface to be measured, comprising:
a measurement head including a first detector and a second detector which detect an interference light between test light that passes through a reference point, is reflected by the surface to be measured, and returns to the reference point, and reference light; and
a processing unit which calculates the shape of the surface to be measured, based on the interference light detected by the first detector while scanning said measurement head along a scanning surface,
wherein the second detector is arranged at a position optically conjugate to the first detector, and
said processing unit calculates, from the interference light detected by the first detector, an optical path length difference between the reference light and the test light,
calculates, from a detection result of the second detector, a wavefront difference between the test light and the reference light,
calculates, from the calculated wavefront difference, a phase error generated between the test light and the reference light owing to the wavefront difference,
corrects the calculated optical path length difference based on the calculated phase error,
calculates a distance between the reference point and the surface to be measured, based on the corrected optical path length difference, and
calculates the shape of the surface to be measured, based on the calculated distance between the reference point and the surface to be measured, and coordinates of the reference point.

6. The apparatus according to claim 5, wherein the second detector is one of an array sensor and a Shack-Hartmann sensor.

7. A measurement method of measuring a shape of a surface to be measured by using a measurement apparatus including a measurement head including a detector which detects an interference light between test light that passes through a reference point, is reflected by the surface to be measured, and returns to the reference point, and reference light, and a processing unit, comprising the steps of:
causing the detector to detect an interference light between the test light and the reference light while scanning the measurement head along a scanning surface;
causing the processing unit to calculate, from the interference light detected by the detector, an optical path length difference between the reference light and the test light;
causing the processing unit to calculate a test wavefront of the test light and a reference wavefront of the reference light on the detector by optical calculation based on a nominal value of the shape of the surface to be measured and optical information of an optical component in the measurement head;
causing the processing unit to calculate, from the calculated test wavefront and reference wavefront, a wavefront difference generated between the test light and the reference light;
causing the processing unit to calculate, from the calculated wavefront difference, a phase error generated between the test light and the reference light owing to the wavefront difference;
causing the processing unit to correct the calculated optical path length difference based on the calculated phase error;
causing the processing unit to calculate a distance between the reference point and the surface to be measured, based on the corrected optical path length difference; and
causing the processing unit to calculate the shape of the surface to be measured, based on the calculated distance between the reference point and the surface to be measured, and coordinates of the reference point.

8. A measurement method of measuring a shape of a surface to be measured by using a measurement apparatus including a measurement head including a first detector and a second detector which detect an interference light between test light that passes through a reference point, is reflected by the surface to be measured, and returns to the reference point, and reference light, and a processing unit, comprising the steps of:
causing the first detector and the second detector to detect an interference light between the test light and the reference light while scanning the measurement head along a scanning surface;
causing the processing unit to calculate, from the interference light detected by the first detector, an optical path length difference between the reference light and the test light;
causing the processing unit to calculate, from a detection result of the second detector, a wavefront difference between the test light and the reference light;
causing the processing unit to calculate, from the calculated wavefront difference, a phase error generated between the test light and the reference light owing to the wavefront difference;
causing the processing unit to correct the calculated optical path length difference based on the calculated phase error;
causing the processing unit to calculate a distance between the reference point and the surface to be measured, based on the corrected optical path length difference; and
causing the processing unit to calculate the shape of the surface to be measured, based on the calculated distance between the reference point and the surface to be measured, and coordinates of the reference point.
